(19) United States
(12) Patent Application Publication
(10) Pub. No.: US 2009/0071178 A1
(43) Pub. Date: Mar. 19, 2009

(54) Vehicle HVAC and Battery Thermal Management

(75) Inventors: Gregory A. Major, Farmington Hills, MI (US); Jeffrey M. Pleune, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/855,178

(22) Filed: Sep. 14, 2007

(51) Int. Cl. B60H 1/02

(52) U.S. Cl. 62/239; 454/75

(57) ABSTRACT

A HVAC and battery thermal management system for a vehicle having a HVAC portion and a battery portion, and a method of operation, is disclosed. The HVAC portion may include a main chamber, an evaporator located in the main chamber, a heater extending across a portion of the main chamber downstream of the evaporator, a battery duct extending from the main chamber adjacent to the heater and in fluid communication with the main chamber both upstream and downstream of the heater. The battery portion may include a battery pack in fluid communication with the battery duct, a battery cooling valve located in the battery duct and configured to selectively allow fluid flow from the main chamber between the evaporator and the heater, and a battery heating valve located in the battery duct and configured to selectively allow fluid flow from the main chamber downstream of the heater.

### BACKGROUND OF INVENTION

The present invention relates generally to a vehicle having a heating ventilation and air conditioning (HVAC) system and an air cooled/heated battery pack.

Some modern automotive vehicles are propelled by electric motors, whether a hybrid electric vehicle, a pure electric vehicle, or some other similar type of vehicle. These vehicles include battery packs for storing electric charge used to drive the motor. A significant amount of energy flow into and out of the battery pack can occur, which may raise the temperature of the battery pack above levels that are desirable. Also, the batteries operate better when above a certain low temperature range. Consequently, some of these vehicles use various techniques for cooling and heating the battery pack. Given the additional cost and complexity of cooling a battery pack, it is thus desirable to cool and heat it in the most efficient and least costly way possible.

In addition, with these vehicles, it is sometimes desirable to heat the passenger cabin while cooling the battery, and vice versa. So, prior art systems may use a complete supplemental HVAC system specifically for heating and cooling the battery pack. It is desirable to reduce or eliminate such supplemental HVAC systems that are used to heat and cool the battery pack since these separate HVAC systems may increase the cost and weight and create packaging problems for these vehicles.

Also, the battery power only range for these vehicles may be reduced due to energy needed to heat or cool the passenger cabin. So, it is desirable to find more efficient ways to heat and cool the passenger cabin of the vehicle as well.

### SUMMARY OF INVENTION

An embodiment contemplates a HVAC and battery thermal management system for a vehicle that includes a HVAC portion and a battery portion. The HVAC portion may include a main chamber having an outside air inlet and a recirculated air inlet, a HVAC blower, an evaporator located in the main chamber, a heater extending across a portion of the main chamber downstream of the evaporator, a battery duct extending from the main chamber adjacent to the heater and in fluid communication with the main chamber both upstream and downstream of the heater, a bypass/shutoff valve adjacent to the heater, and a temperature control and shutoff valve located in the main chamber downstream of the heater and downstream of the battery duct. The battery portion may include a battery pack in fluid communication with the battery duct, a battery cooling valve located in the battery duct and configured to selectively allow fluid flow from the main chamber between the evaporator and the heater, a battery heating valve located in the battery duct and configured to selectively allow fluid flow from the main chamber downstream of the heater, and a pressure relief duct in fluid communication with the battery pack and selectively in fluid communication with atmosphere outside of the vehicle.

An embodiment contemplates a HVAC and battery thermal management system for a vehicle having a HVAC portion and a battery portion. The HVAC portion may include a main chamber, a HVAC blower, an evaporator located in the main chamber, a heater extending across a portion of the main chamber downstream of the evaporator, a battery duct extending from the main chamber adjacent to the heater and in fluid communication with the main chamber upstream of the heater. The battery portion may include a battery pack in fluid communication with the battery duct, a battery cooling valve located in the battery duct and configured to selectively allow fluid flow from the main chamber between the evaporator and the heater, and a pressure relief duct in fluid communication with the battery pack and selectively in fluid communication with atmosphere outside of the vehicle.

An embodiment contemplates a method of heating and cooling a battery pack of a vehicle, the method comprising the steps of: drawing air through an evaporator in a main chamber of a HVAC module; selectively flowing air through a heater in the main chamber downstream of the evaporator; selectively flowing air from between the evaporator and the heater through a battery duct to a battery pack; selectively flowing air from downstream of the heater through the battery duct to the battery pack; and selectively flowing air from the battery pack, through a duct, to one of a body pressure relief vent and a passenger cabin.

An advantage of an embodiment is that the vehicle HVAC module is employed not only to heat and cool the passenger cabin, but also the battery pack. Thus, no additional supplemental HVAC system is required for heating and cooling the battery pack. One may employ supplemental heating in the battery pack if desired, or just use heating from HVAC system. Also, no additional filtration or water separation is required for battery pack heating and cooling since the HVAC module takes care of these functions for both.

An advantage of an embodiment is that, even though no separate battery HVAC system is employed, simultaneous cabin heating and battery cooling can be achieved and vice versa.

An advantage of an embodiment is that the passenger cabin and the battery can be preconditioned (i.e., a more desirable temperature achieved) prior to occupants entering the vehicle. This preconditioning may be activated by a key fob, or it may be automatically activated while the vehicle is plugged-in charging the battery pack. The preconditioning may be particularly useful if the vehicle is plugged-in charging while the vehicle is in a hot soak (e.g., parked in the sun on a hot day), since the preconditioning may increase battery performance and battery life. The preconditioning may be achieved either with just fresh air circulation or with operation of the air conditioning system to further cool and dehumidify the air in the vehicle.

An advantage of an embodiment is that air warmed by flowing through the battery pack may be directed to the passenger cabin to avoid negative pressure in the cabin and to provide supplemental heating to the cabin, when desired. Supplemental heating may allow for less energy required from the battery pack for HVAC heating of the passenger cabin during vehicle operation, thus increasing vehicle electric only range.

### BRIEF DESCRIPTION OF DRAWINGS

FIG. 1 is a schematic diagram of a vehicle according to a first embodiment.

FIG. 2 is a schematic diagram of a HVAC and battery thermal management system according to the first embodiment.

FIG. 3 is a schematic diagram of a HVAC and battery thermal management system according to a second embodiment.

FIG. 4 is a schematic view similar to FIG. 3, illustrating an example of an air flow path for a battery heat mode.

FIG. 5 is a schematic view similar to FIG. 3, illustrating another example of an air flow path for a battery heat mode.

FIG. 6 is a schematic view similar to FIG. 3, illustrating another example of an air flow path for a battery heat mode.

FIG. 7 is a schematic view similar to FIG. 3, illustrating another example of an air flow path for a battery heat mode.

FIG. 8 is a schematic diagram of a HVAC and battery thermal management system according to a third embodiment.

FIG. 9 is a schematic diagram of a HVAC and battery thermal management system according to a fourth embodiment.

FIG. 10 is a schematic diagram of a vehicle according to a fifth embodiment.

### DETAILED DESCRIPTION

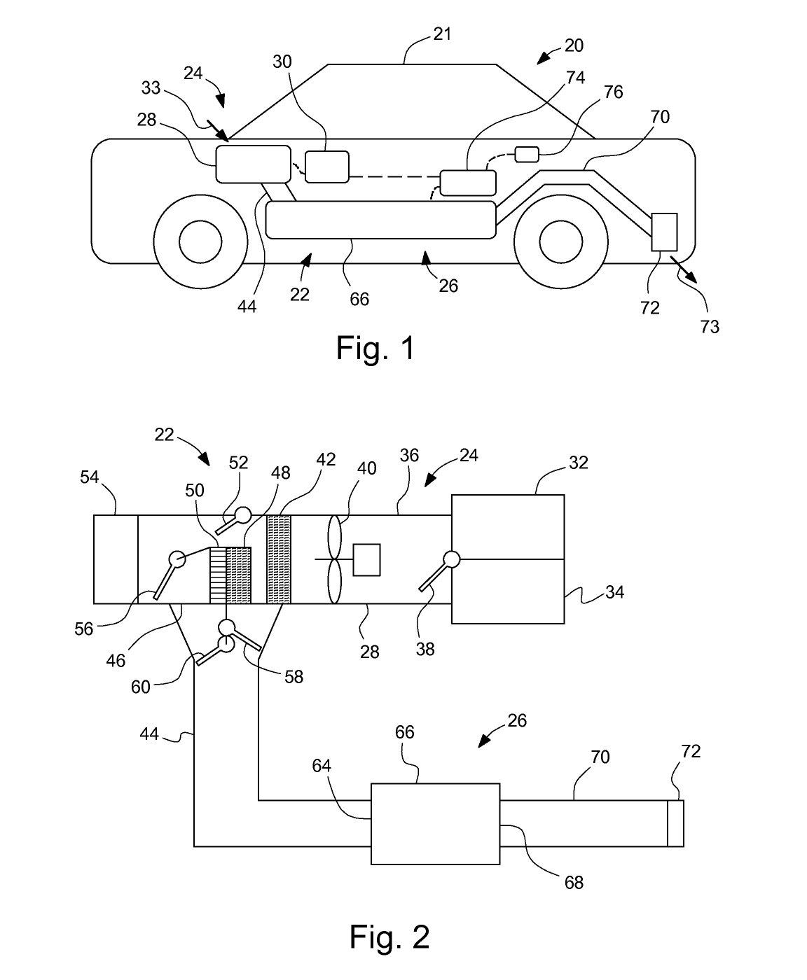

Referring to FIGS. 1-2, a vehicle, indicated generally at 20, having a passenger cabin 21, is shown. The vehicle may be, for example, an electric vehicle, a hybrid electric vehicle, a plug-in hybrid electric vehicle, or a fuel cell vehicle. The vehicle 20 includes a heating, ventilation and air conditioning (HVAC) and battery thermal management system 22. This thermal management system 22 includes a HVAC portion 24 and a battery portion 26.

The HVAC portion 24 includes a HVAC module 28 that is in communication with and controlled by a HVAC controller 30 (the communication lines indicated by dashed lines). The HVAC module 28 includes an outside air inlet 32, into which air can be drawn into the vehicle from the atmosphere (typically the vehicle cowl, as indicated by arrow 33), and a recirculated air inlet 34, into which air is drawn from the passenger cabin 21. The two inlets 32, 34 are selectively in fluid communication with a main chamber 36, with a fresh/recirculated air valve 38 selectively blocking part or all of the air flow between the inlets 32, 34 and the main chamber 36. The position of the air valve 38 may be controlled by the HVAC controller 30. A HVAC blower 40 is mounted in the main chamber 36 and may be controlled by the controller 30 to cause air to flow through the main chamber 36.

An evaporator 42 is mounted in and extends across the width of the main chamber 36 downstream of the HVAC blower 40 and may be connected to a remaining portion of an air conditioning system in a conventional fashion. Downstream of the evaporator 42 a battery duct 44 splits off from the main chamber 36. Adjacent to an entrance 46 of the battery duct 44 are a heater core 48 and a supplemental heater 50. The heaters 48, 50 extend only a portion of the way across the width of the main chamber 36. The heater core 48 may be connected to an engine coolant system in a conventional manner, and the supplemental heater 50 may be electrically powered.

A bypass/shutoff valve 52 is adjacent to the heaters 48, 50 and selectively extends across the rest of the width of the main chamber 36. The position of this valve 52 determines whether air flow is directed through or can flow around the heaters 48, 50 before flowing into a cabin air distribution portion 54 of the HVAC module 28. A temperature control and shutoff valve 56 is located downstream of the heaters 48, 50 and the battery duct 44. The position of this valve 52 determines whether air flowing through the heaters 48, 50 is allowed to flow into the cabin air distribution portion 54 or is directed into the battery duct 44. A battery cooling valve 58 and a battery heating valve 60 are located in the battery duct 44 just downstream of the entrance 46. The position of the battery cooling valve 58 determines whether air flowing from the evaporator 42 is allowed to flow into the battery duct 44, and the position of the battery heating valve 60 determines whether air flowing from the heaters 48, 50 is allowed to flow into the battery duct 44.

The battery duct 44 of the battery portion 26 extends to an entrance 64 to a battery pack 66. Air flowing through the battery duct 44 is directed through the battery pack 66 to a battery pack exit 68 connected to a pressure relief duct 70 that is, in turn, connected to a body pressure relief vent 72. The body pressure relief vent 72 is a one-way vent that allows air to flow from the pressure relief duct 70 to atmosphere outside the vehicle 20 (as indicated by arrow 73) when the air pressure in the relief duct 70 is above the atmospheric pressure by a certain amount, but does not let air flow through the vent 72 into the relief duct 70. The battery portion 26 may also include a battery pack controller 74 in communication with the HVAC controller and a plug-in charger 76.

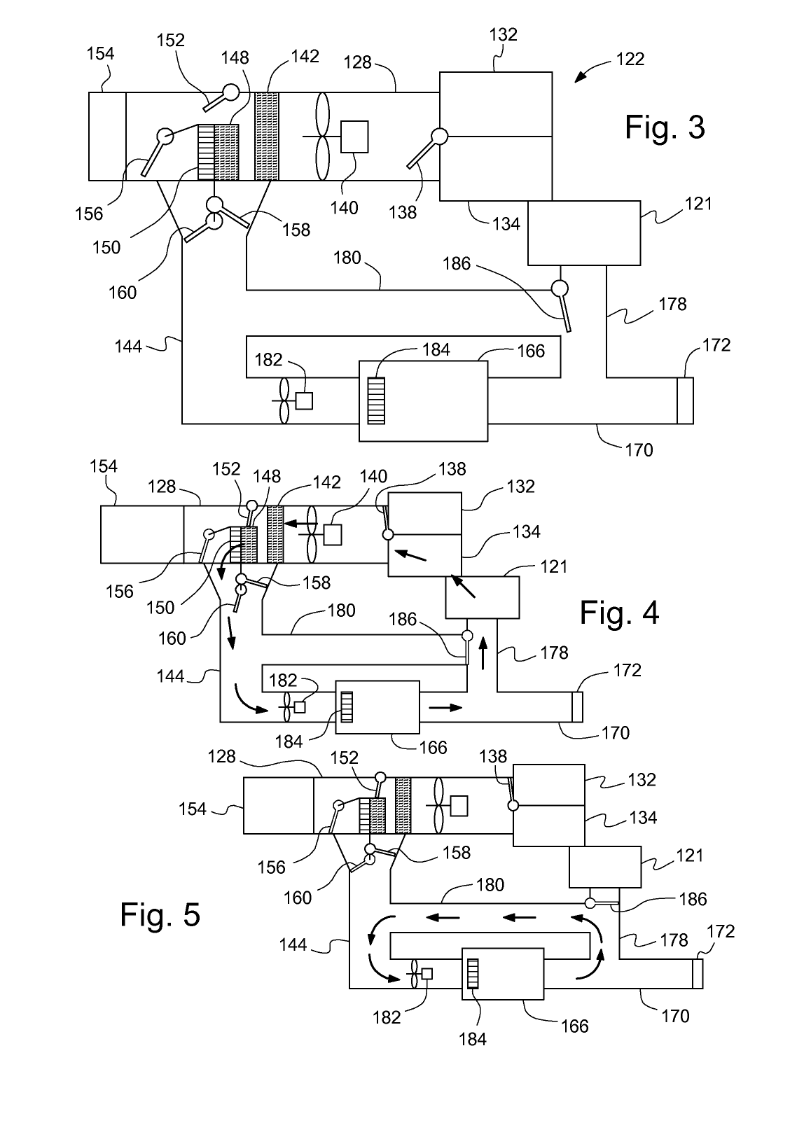

FIGS. 3-7 illustrate a second embodiment. Since this embodiment is similar to the first, similar element numbers will be used for similar elements, but employing 100-series numbers. The ability of the battery pack 166 to receive air flow from the HVAC module 128 through the battery duct 144, with the valves 138, 152, 156, 158, 160 directing air flow and the evaporator 142 and heaters 148, 150 cooling/heating the air, is essentially the same as the first embodiment. The HVAC module 128 still pulls air in via one or both of the outside air inlet 132 and the recirculated air inlet 134, and may selectively discharge air to the cabin air distribution portion 154. The battery pack also still connects to the body pressure relief vent 172 via the pressure relief duct 170.

The second embodiment adds some features to enhance the flexibility of the HVAC and battery thermal management system 122. A battery-to-cabin recirculation duct 178 is added that connects the pressure relief duct 170 and the cabin 121. Also, a battery recirculation duct 180 connects the battery-to-cabin recirculation duct 178 to the battery duct 144. A battery recirculation valve 186 is located at the intersection of the battery-to-cabin recirculation duct 178 and the battery recirculation duct 180. This valve 186 selectively directs air flow into the battery recirculation duct 180 or into the cabin 121. An optional battery blower 182 is located in the battery duct 144 upstream of the battery pack 166 to supplement the HVAC blower 140 or provide flow when battery air recirculation (discussed below) is desired. Also, an optional battery heater 184 is located in the battery pack 166 to supplement heat from the heaters 148, 150 or provide heat when battery air recirculation and battery heating is desired.

FIG. 4 shows an air flow path that may be used while the vehicle 120 is plugged-in for battery charging when it is desirable to warm the battery pack 166 while charging. The arrows show the flow of air in the desired air flow path. In this battery heat mode, the fresh/recirculated air valve 138 is positioned to recirculate air from the passenger cabin 121. The HVAC blower 140 forces air through the evaporator 142 (preferably without cooled refrigerant flowing through it). With the bypass/shutoff valve 152, temperature control and shutoff valve 156, and battery cooling valve 158 closed, and the battery heating valve 160 open, air is forced through the heater core 148 and supplemental heater 150. Since this is a battery charging mode, it is unlikely that the engine coolant is hot, so the supplemental heater 150 is activated to warm the air as it flows through the supplemental heater 150. The warmed air then flows through the battery duct 144 and through the battery pack 166 to warm the batteries. The optional battery blower 182 may be activated to assist with air flow, and the optional battery heater 184 may be activated to further warm the air, if so desired. Alternatively, for this mode, the battery blower 182 and battery heater 184 may provide the air flow and heat, respectively, instead of the HVAC blower 140 and supplemental heater 150. After the air flows from the battery pack 166, the battery recirculation valve 186 is positioned to direct the air through the battery-to-cabin recirculation duct 178 back into the passenger cabin 121.

FIG. 5 shows an air flow path that may be used while the vehicle is plugged-in for battery charging when it is desirable to warm the battery while charging. In order to create this flow path, the battery recirculation valve 186 blocks flow from the battery pack 166 back to the passenger cabin 121, and the battery heating valve 160 and battery cooling valve 158 are closed. In contrast with the flow path of FIG. 4, the HVAC blower 140 and heaters 148, 150 are not employed. The battery blower 182 is activated to circulate the air, and the battery heater 184 is activated to warm the air. The air, then, flows from the battery duct 144, through the battery pack 166, through a portion of the pressure relief duct 170 into the battery-to-cabin recirculation duct 178 and is then directed into the battery recirculation duct 180. While this flow path is shorter and may have less heat loss than that in FIG. 4, it does require the battery blower 182 and battery heater 184 be present in the particular vehicle, rather than those components being optional to the system.

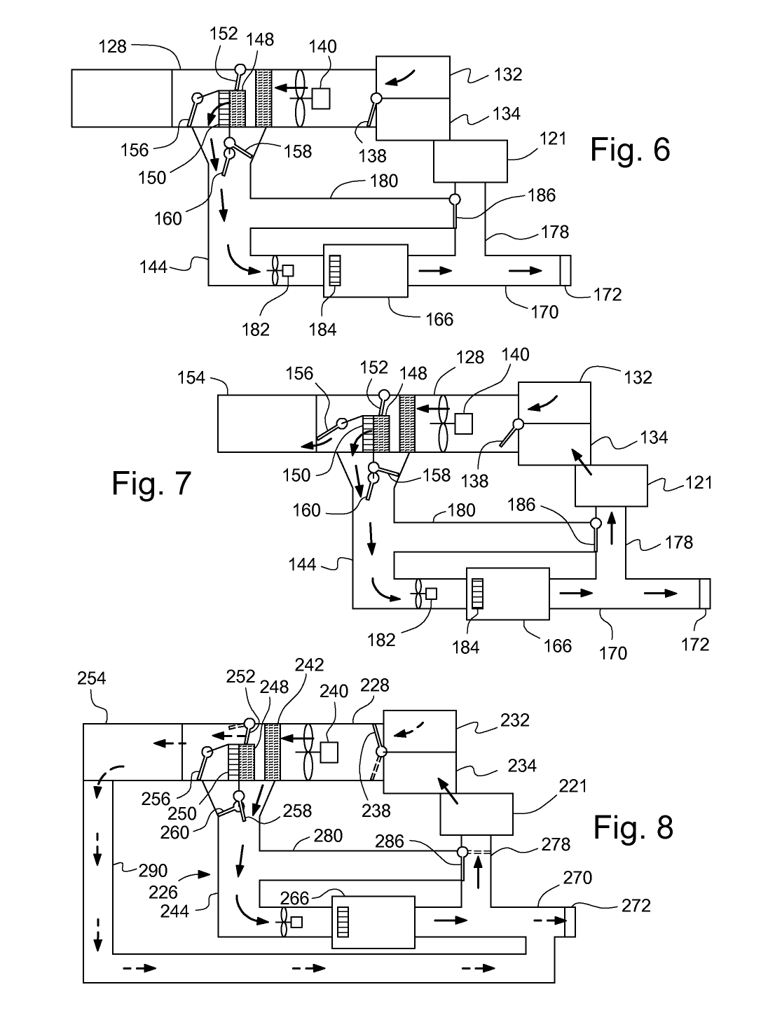

FIG. 6 shows an air flow path that may be used while operating the vehicle when it is desirable to warm the battery. In order to create this flow path, the battery recirculation valve 186 blocks air flow into the battery recirculation duct 180, the fresh/recirculated air valve is oriented to pull flow from the outside air inlet 132, and the battery heating valve 160 is open. The battery cooling valve 158, bypass shutoff valve 152 and temperature control and shutoff valve 156 are closed. The HVAC blower 140, then, will pull outside air into the vehicle, and create an air flow that passes through the heater core 148 and supplemental heater 150, where it is warmed, and then through the battery duct 144 to the battery pack 166. Upon exiting the battery pack 166, since additional air is brought in from outside of the vehicle, the air will naturally flow through the pressure relief duct 170 and, as the pressure builds, the body pressure relief vent 172 will open, allowing the air to exit the vehicle. For this air flow path, the battery blower 182 and battery heater 184 are optional since the air flow and heat can be generated in the HVAC module 128.

FIG. 7 shows an air flow path that may be used while operating the vehicle when it is desirable to warm the vehicle and also warm the cabin. The flow path is similar to that in FIG. 6, but the temperature control and shutoff valve 156 is opened so that a portion of the air warmed by the heater core 148 and/or supplemental heater 150 flows into the cabin air distribution portion 154 of the HVAC module 128. Another portion of the air still flows past the battery heating valve 160, with the temperature control and shutoff valve 156 controllable to vary the percentage of air flowing in each direction. Also, the fresh/recirculation air valve 138 can be adjusted to vary the percentage of fresh versus recirculated air that is drawn into the HVAC module 128, which, in turn, determines the proportion of air that flows through the battery-to-cabin recirculation duct 180 rather than through the body pressure relief vent 172. For this airflow path, the battery blower 182 and battery heater 184 are optional since the air flow and heat can be generated in the HVAC module 128. The positioning of the valves for optimal heat load and minimizing battery consumption during electric only driving may be enhanced by adding humidity sensor (not shown)—allowing for optimal settings during a defrost mode of HVAC module operation since recirculation reduces the heat load, but fresh air allows for reduction of humidity.

FIG. 8 illustrates a third embodiment. Since this embodiment is similar to the second, similar element numbers will be used for similar elements, but employing 200-series numbers. This embodiment still has a HVAC module 228 including an outside air inlet 232, recirculated air inlet 23, from a passenger cabin 221, a fresh/recirculated air valve 238, HVAC blower 240, evaporator 242, heater core 284, supplemental heater 250, bypass shutoff valve 252, temperature control and shutoff valve 256, and cabin air distribution portion 254. Also, the battery portion 226 still includes a battery cooling valve 258 and a battery heating valve 260 in a battery duct 244 leading to a battery pack 266, a pressure relief duct 270 leading to a body pressure relief vent 272 and a battery-to-cabin recirculation duct 178, and a battery recirculation valve 286 that selectively allows air flow into a battery recirculation duct 280. However, unlike the second embodiment, this embodiment includes a cabin venting flow path 290 that directs air flow from the cabin air distribution portion 254 (via a passenger cabin flow path) to the pressure relief duct 270. Thus, some or all of the air flow can bypass the battery pack 266 when being directed to the body pressure relief vent 272 or back to be recirculated through the HVAC module 228.

FIG. 8 also shows two possible air flow paths for cooling the battery pack 266 while the vehicle is plugged-in for battery charging. The air flow path for the first mode is indicated by the solid arrows and the valve positions are shown in solid lines. In this mode the HVAC blower 240 draws air in through the recirculated air inlet 234, through the evaporator 242, where it is cooled, and past the battery cooling valve 258 into the battery duct 244. The air flows through the battery pack 266, into the pressure relief duct 270 and then through the battery-to-cabin recirculation duct 278 to complete the loop.

The flow path for the second mode of operation allows for cabin cooling (and battery pack cooling, if desired) while the vehicle is plugged-in for battery charging. The changes in the flow path and valve positions for this mode are indicated by dashed lines. Air is drawn in from the outside air inlet 232 by the HVAC blower 240 and then directed into both the battery duct 244 and the cabin air distribution portion 254. The air flowing into the cabin air distribution portion 254 rejoins the air flowing through the battery pack 266 in the pressure relief duct 270 before flowing out through the body pressure relief vent.

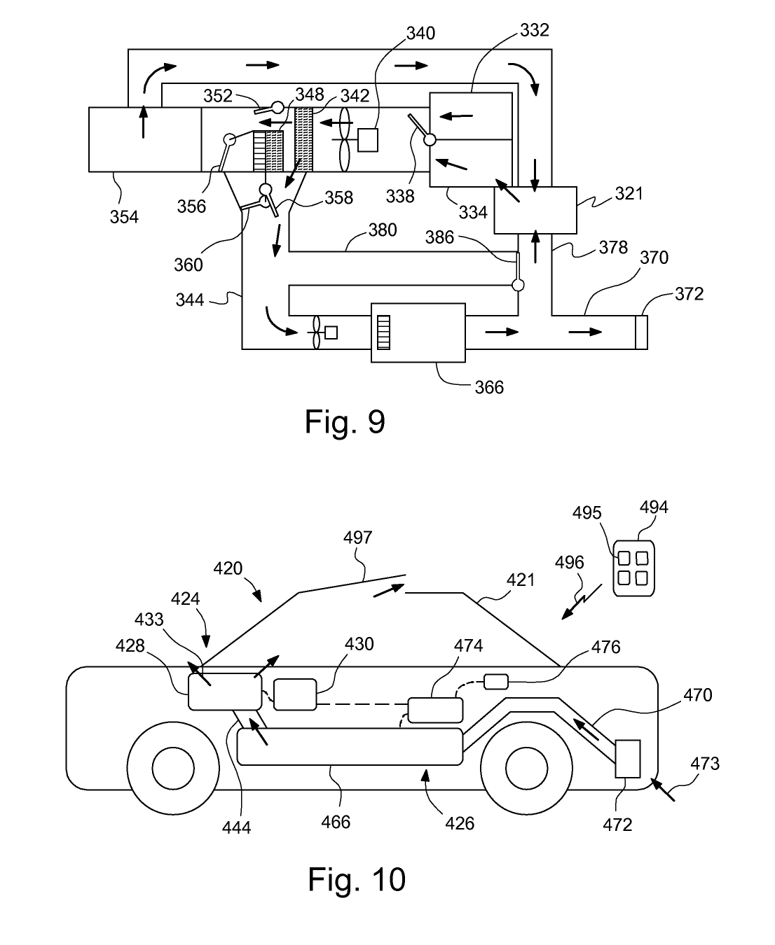

FIG. 9 illustrates a fourth embodiment. Since this embodiment is similar to the second, similar element numbers will be used for similar elements, but employing 300-series numbers. In this embodiment cooled air flow is shown flowing through both the passenger cabin 321 and the battery pack 366 simultaneously. These air flow paths allow for cooling the battery pack 366 and cabin 321 while operating the vehicle.

For the first air flow path, the HVAC blower 340 draws part of its air through the recirculated air inlet 334 and the rest through the outside air inlet 332, and directs it through the evaporator 342, where it is cooled. With the temperature control and shutoff valve 356 and the battery heating valve 360 closed, and the battery cooling valve 358 open, a portion of the air flows through the battery duct 344, through the battery pack 366 and into the pressure relief duct 370. The air flow then flows partially out through the body pressure relief vent 372, and partially through the battery-to-cabin recirculation duct 180 to the passenger cabin 321. The battery recirculation valve 386 blocks flow into the battery recirculation duct 380. For the second flow path, the bypass/shutoff valve 352 is open so a portion of the air flowing through the evaporator 342 flows through the cabin air distribution portion 354 to the passenger cabin 321 and back to the recirculated air inlet 334. As an option, the heater core 348 has a shut-off valve to prevent hot engine coolant from being circulated through it when in the cooling mode.

FIG. 10 illustrates a fifth embodiment. Since this embodiment is similar to the first, similar element numbers will be used for similar elements, but employing 400-series numbers. This vehicle 420 has a passenger cabin 421 that has an automated way to allow air to escape from a mid to upper portion of the cabin 421. The air escape may be an automatically opening sun roof 497 or may be reverse air flow 433 through a portion of a vehicle cowl in communication with the HVAC module 428 of the HVAC portion 424. For this vehicle, a battery pack 466 still connects to the HVAC module 428 via the battery duct 444 and connects to the body pressure relief vent 472 via the pressure relief duct 470. The body pressure relief vent 472 for this embodiment, however, is controllable. That is, it is electronically controllable to allow for reverse flow through the vent in certain situations. Optionally, the body pressure relief vent 472 may include a screen or baffle (not shown) to minimize the possibility for debris or animal intrusion into the vent.

The vehicle 420 still includes the HVAC controller 430 in communication with the battery pack controller 474, which is in communication with the battery pack 466 and the plug-in charger 476. There may also be an optional rain sensor (not shown) if a cooling mode includes the automatically opening the sunroof 497 or a window (not shown) to prevent rain from entering the vehicle. There may also be an optional interior intrusion detector (not shown) to deter theft if a cooling mode includes the automatically opening sunroof 497 or window.

With this vehicle 420, when the vehicle is parked in a hot soak condition (parked in the sun on a hot day), the body pressure relief vent 472 and the sunroof 497 are opened. Since the vent 472 is lower than the sunroof 497, passive convective flow from the vent 472 to the sunroof 497 will occur. The air flow 473 into the pressure relief duct 470 will flow through the battery pack 466, the battery duct 444, and into the HVAC module 428. The air will then flow through the passenger cabin 421 and out through the sunroof 497. As an alternative, the air flow path may be through the HVAC module 428 and out through the cowl rather than through the sunroof 497. While this alternative allows for battery pack cooling, the passenger compartment cooling is not as effective. For another alternative, one may employ one of the blowers to improve over merely convective flow cooling.

In addition to automated passive cooling when the vehicle 420 is in a hot soak, one may also employ a key fob 494 having a button 495 that will send a signal 496 causing the vehicle 420 to activate passive cooling.

While certain embodiments of the present invention have been described in detail, those familiar with the art to which this invention relates will recognize various alternative designs and embodiments for practicing the invention as defined by the following claims.

What is claimed is:

1. A HVAC and battery thermal management system for a vehicle comprising:
a HVAC portion including a main chamber having an outside air inlet and a recirculated air inlet, a HVAC blower, an evaporator located in the main chamber, a heater extending across a portion of the main chamber downstream of the evaporator, a battery duct extending from the main chamber adjacent to the heater and in fluid communication with the main chamber both upstream and downstream of the heater, a bypass/shutoff valve adjacent to the heater, and a temperature control and shutoff valve located in the main chamber downstream of the heater and downstream of the battery duct; and
a battery portion including a battery pack in fluid communication with the battery duct, a battery cooling valve located in the battery duct and configured to selectively allow fluid flow from the main chamber between the evaporator and the heater, a battery heating valve located in the battery duct and configured to selectively allow fluid flow from the main chamber downstream of the heater, and a pressure relief duct in fluid communication with the battery pack and selectively in fluid communication with atmosphere outside of the vehicle.

2. The HVAC and battery thermal management system of claim 1 wherein the battery portion includes a battery-to-cabin recirculation duct in fluid communication between the pressure relief duct and a passenger cabin, a battery recirculation duct in fluid communication between the battery-to-cabin recirculation duct and the battery duct, and a battery recirculation valve configured to selectively block fluid flow into the battery recirculation duct.

3. The HVAC and battery thermal management system of claim 2 wherein the HVAC portion includes a fresh/recirculated air valve configured to selectively control proportions of air flow from the outside air inlet and the recirculated air inlet.

4. The HVAC and battery thermal management system of claim 2 wherein the battery portion includes a battery blower located in the battery duct and a battery heater located in the battery pack.

5. The HVAC and battery thermal management system of claim 1 wherein the HVAC portion includes a cabin air distribution portion, the bypass shutoff valve is configured to selectively allow fluid flow from the evaporator to bypass the heater and flow into the cabin air distribution portion, the temperature control and shutoff valve is configured to selectively allow fluid flow through the heater to flow into the cabin air distribution portion, and the cabin air distribution portion is in fluid communication with a cabin venting flow path that is in fluid communication with the pressure relief duct.

6. The HVAC and battery thermal management system of claim 1 wherein the heater is a heater core and a supplemental heater adjacent to the heater core.

7. The HVAC and battery thermal management system of claim 1 wherein the battery portion includes a battery blower located in the battery duct.

8. The HVAC and battery thermal management system of claim 1 wherein the battery portion includes a battery heater located in the battery pack.

9. The HVAC and battery thermal management system of claim 1 including a controllable body pressure relief vent in fluid communication with the pressure relief duct and configured to selectively allow for inflow of air into the pressure relief duct.

10. The HVAC and battery thermal management system of claim 9 including an automated sunroof configured to be openable upon the controllable body pressure relief vent allowing inflow of air.

11. The HVAC and battery thermal management system of claim 9 including a key fob having a button for sending a wireless signal to cause the actuation of the controllable body pressure relief vent to allow inflow of air.

12. A HVAC and battery thermal management system for a vehicle comprising:
a HVAC portion including a main chamber, a HVAC blower, an evaporator located in the main chamber, a heater extending across a portion of the main chamber downstream of the evaporator, and a battery duct extending from the main chamber adjacent to the heater and in fluid communication with the main chamber upstream of the heater; and
a battery portion including a battery pack in fluid communication with the battery duct, a battery cooling valve located in the battery duct and configured to selectively allow fluid flow from the main chamber between the evaporator and the heater, and a pressure relief duct in fluid communication with the battery pack and selectively in fluid communication with atmosphere outside of the vehicle.

13. The HVAC and battery thermal management system of claim 12 wherein the battery portion includes a battery blower located in the battery duct and a battery heater located in the battery pack.

14. The HVAC and battery thermal management system of claim 12 wherein the battery portion includes a battery-to-cabin recirculation duct in fluid communication with the pressure relief duct, a battery recirculation duct in fluid communication between the battery-to-cabin recirculation duct and the battery duct, and a battery recirculation valve configured to selectively block fluid flow into the battery recirculation duct.

15. The HVAC and battery thermal management system of claim 12 wherein the battery duct is also in fluid communication with the main chamber downstream of the heater, and the battery portion includes a battery heating valve located in the battery duct and configured to selectively allow fluid flow from the main chamber downstream of the heater through the battery duct.

16. A method of heating and cooling a battery pack of a vehicle, the method comprising the steps of:
(a) drawing air through an evaporator in a main chamber of a HVAC module;
(b) selectively flowing air through a heater in the main chamber downstream of the evaporator;
(c) selectively flowing air from between the evaporator and the heater through a battery duct to a battery pack;
(d) selectively flowing air from downstream of the heater through the battery duct to the battery pack; and
(e) selectively flowing air from the battery pack, through a duct, to one of a body pressure relief vent and a passenger cabin.

17. The method of claim 16 wherein step (e) is further defined by selectively flowing air from the battery pack through a battery recirculation duct to the battery duct, and the method further includes the step of (f) creating air flow through the battery pack with a battery blower located adjacent to the battery pack.

18. The method of claim 16 wherein step (b) is further defined by the heater being at least one of a heater core and a supplemental heater, and selectively flowing air through the at least one of the heater core and the supplemental heater.

19. The method of claim 16 wherein step (c) is further defined by actuating a battery cooling valve in the battery duct to selectively allow the flow of air from between the evaporator and the heater into the battery duct, and step (d) is further defined by actuating a battery heating valve in the battery duct to selectively allow the flow of air from downstream of the heater into the battery duct.

20. The method of claim 16 wherein the body pressure relief vent is a controllable body pressure relief vent, and the method includes (f) selectively allowing reverse air flow from the body pressure relief vent into the battery pack.
